(19) United States
(12) Patent Application Publication
(10) Pub. No.: US 2023/0188407 A1
(43) Pub. Date: Jun. 15, 2023

(54) INCIDENT ALERTS

(71) Applicant: Hewlett-Packard Development Company, L.P., Spring, TX (US)

(72) Inventors: Mayuri Mohite, Pune (IN); Narendra Kumar Chincholikar, Pune (IN); Brijesh Kartha, Pune (IN)

(73) Assignee: Hewlett-Packard Development Company, L.P., Spring, TX (US)

(21) Appl. No.: 18/064,687

(22) Filed: Dec. 12, 2022

(30) Foreign Application Priority Data
Dec. 15, 2021 (IN) 202141058354

(51) Int. Cl. H04L 41/06; H04L 41/147; H04N 7/15

(52) U.S. Cl. CPC H04L 41/06; H04L 41/147; H04N 7/15

(57) ABSTRACT

In some examples, a non-transitory machine-readable medium stores machine-readable instructions, which, when executed by a processor, cause the processor to receive operational data of a videoconferencing solution, to predict, utilizing a machine learning process on the operational data, an incident of the videoconferencing solution, and to generate, based on the prediction, an incident alert.

### BACKGROUND

Videoconferencing solutions facilitate meetings between users utilizing executable code that enables videoconferencing sessions. To enable communications during a videoconferencing session, a videoconferencing solution includes multiple peripheral devices such as audio devices, image sensors, touchscreens, display devices, or a combination thereof. Operational data of the videoconferencing solution provides information useful in analyzing and diagnosing irregular operations that occur while utilizing the videoconferencing solution.

### BRIEF DESCRIPTION OF THE DRAWINGS

Various examples are described below referring to the following figures.

FIG. 1 is a flow diagram depicting a method for a system for generating incident alerts, in accordance with various examples.

FIG. 2 is a block diagram depicting a system for generating incident alerts, in accordance with various examples.

FIG. 3 is a block diagram depicting an electronic device for generating incident alerts, in accordance with various examples.

FIG. 4 is a block diagram depicting a system for generating incident alerts, in accordance with various examples.

FIG. 5 is a flow diagram depicting a method for a system for generating incident alerts, in accordance with various examples.

FIG. 6 is a flow diagram depicting a method for a system for generating incident alerts, in accordance with various examples.

### DETAILED DESCRIPTION

As described above, a videoconferencing solution that includes multiple peripheral devices facilitates videoconferencing sessions. A videoconferencing session enables a user to meet with other users, some of whom may be remote. A remote user, as used herein, is a user who attends the videoconferencing session at a second location that is different from a first location of the videoconferencing solution. In some instances, the videoconferencing solution experiences irregular operations during the videoconferencing session. An irregular operation, as used herein, includes a delay of the videoconferencing session, a premature termination of the videoconferencing session, an improper performance of a peripheral device of the videoconferencing solution, or a combination thereof. The delay, as used herein, is a lag time from transmission of a signal (e.g., an audio signal, a video signal) to reception of the signal or is a time period utilized while attempting to diagnose a cause of the irregular operation, correct the irregular operation, or a combination thereof. The improper performance of the peripheral device is a degradation in sound quality, a degradation in video quality, an increase in lag time, or any other operational aberration. The irregular operation is herein referred to as an incident. In many instances, the incident is caused by an aberrant behavior of a hardware component, an executable code, or a combination thereof, of the videoconferencing solution. However, determining a cause of the incident is difficult for the user due to lack of knowledge, the multiple components of the videoconferencing solution, the multiple videoconferencing solutions in use, or a combination thereof.

Waiting until an incident occurs during the videoconferencing session detracts from the experience of the users of the videoconferencing session. The incident negatively impacts productivity of the users by distracting from, slowing, or ending the videoconferencing session. In some instances, the users fail to report the incident, which detracts from the experience and productivity of future users of the videoconferencing solution. In other instances, the users are uncertain whether the videoconferencing solution at the first location or a second videoconferencing solution at the second location caused the incident. In various instances, the user contacts a technician, service center, or a combination thereof, and is asked to help diagnose the incident because of proximity to the videoconferencing solution, further reducing user productivity. The contacted technician, service center, or a combination thereof, of the videoconferencing solution, while having the knowledge to diagnose a cause of the incident, may not have a replacement part available, resulting in increased downtime of the videoconferencing solution.

To enhance user experience and productivity during a videoconferencing session, a system generates incident alerts from operational data of a videoconferencing solution. Operational data, as used herein, is data of the videoconferencing solution, a user of the videoconferencing solution, a technician of the videoconferencing solution, a service center of the videoconferencing solution, or a combination thereof. The operational data includes identifying data, informational data, historical data, real-time data, or a combination thereof. The identifying data includes an identifier, a location, a time, or any other suitable data that indicates an identity of the videoconferencing solution, the user, the technician, the service center, or the combination thereof. The informational data includes inventory, availability, technical specifications, warranty status, recall status, hardware version, executable code version, available updates, or any other suitable data that is static during operations of the videoconferencing solution. The historical data includes manufacturing date, installation date, time in use, previous incidents, or any other data collected in a past videoconferencing session. The real-time data includes current health, event data, or other data collected at a specified interval during a current videoconferencing session. Event data, as used herein, is generated responsive to a peripheral device of the videoconferencing solution connecting or disconnecting from a network, experiencing a configuration error, or experiencing any other change in operation.

A processor of the system receives the operational data. In some examples, the operational data is for multiple videoconferencing solutions. For example, the operational data may be for videoconferencing solutions having the same, or some of the same, peripheral device configurations, located at a same location, owned by a same enterprise, or a combination thereof. Given the multiple peripheral devices that are included in a videoconferencing solution, the amount of operational data collected over a day may amount to hundreds or thousands of data points. The processor analyzes the operational data to predict an incident. In some examples, the processor utilizes machine learning processing to analyze the operational data. The machine learning processing is trained utilizing identifying data, informational data, historical data, of a combination thereof, of the videoconferencing solution. The machine learning processing utilizes time series regression processing, in some examples. The time series regression processing utilizes moving averages, for example. Responsive to the prediction of the incident, the processor generates an incident alert. The incident alert includes generating an incident notification, updating executable code, updating configuration settings, generating a report, redirecting the user to another videoconferencing solution location, or a combination thereof. The incident notification, as used herein, notifies a technician, a service center, or a combination thereof, about the impending incident, along with a location of the incident. Updating executable code, as used herein, includes installing additional executable code, update existing executable code, or a combination thereof. The report, as used herein, identifies which peripheral device of the videoconferencing solution is predicted to experience the incident, an estimation of when the incident will occur, a recommendation for resolving the incident, a technician for servicing the videoconferencing solution, a location of a service center for servicing the peripheral device, or a combination thereof.

By utilizing the machine learning processing to predict an incident and generating an incident alert responsive to the incident, the processor enables correction of the incident before the incident impacts the productivity of the videoconferencing solution. The user experience and productivity are enhanced by ensuring the videoconferencing solution operates as intended during use. Analyzing the operational data utilizing the machine learning processing enhances a productivity of the technician, the service center, or a combination thereof by diagnosing the incident, determining a cause of the incident, and generating a recommendation to correct the incident. The processor tracking inventory enhances the productivity of the technician, the service center, or the combination thereof, by ensuring the incident is resolved by a technician, a service center, or a combination thereof, that has access to the proper inventory. The processor updating executable code, configuration settings, or a combination thereof, during a downtime of the videoconferencing solutions enhances a productivity of the videoconferencing solution by eliminating a time utilized by a technician to travel to the videoconferencing solution to perform the update. Diagnosing the incident, determining the cause of the incident, generating the recommendation to correct the incident, and ensuring proper service routing for resolution of the incident enhances the productivity of the videoconferencing solution by reducing an amount of downtime for servicing the videoconferencing solution.

In some examples in accordance with the present description, a non-transitory machine-readable medium is provided. The term “non-transitory” does not encompass transitory propagating signals. The non-transitory machine-readable medium stores machine-readable instructions, which, when executed by a processor, cause the processor to collect operational data of a videoconferencing solution, to predict, utilizing a machine learning process on the operational data, an incident of the videoconferencing solution, and to generate, based on the prediction, an incident alert.

In other examples in accordance with the present description, a system is provided. The system includes a network interface and a processor. The processor is to receive operational data of multiple videoconferencing solutions via the network interface, filter the operational data by a type of multiple peripheral devices of the videoconferencing solutions, predict, utilizing machine learning processing on the filtered operational data, an incident of a peripheral device of the multiple peripheral devices, and, generate, based on the prediction, an incident alert.

In yet other examples in accordance with the present description, a method is provided. The method includes collecting operational data of multiple videoconferencing solutions, filtering the operational data, identifying a feature of the filtered operational data, predicting, utilizing a time series regression processing on the feature, an incident, and generating, based on the prediction, an incident alert, the incident alert to include updating a configuration setting of a videoconferencing solution of the multiple videoconferencing solutions.

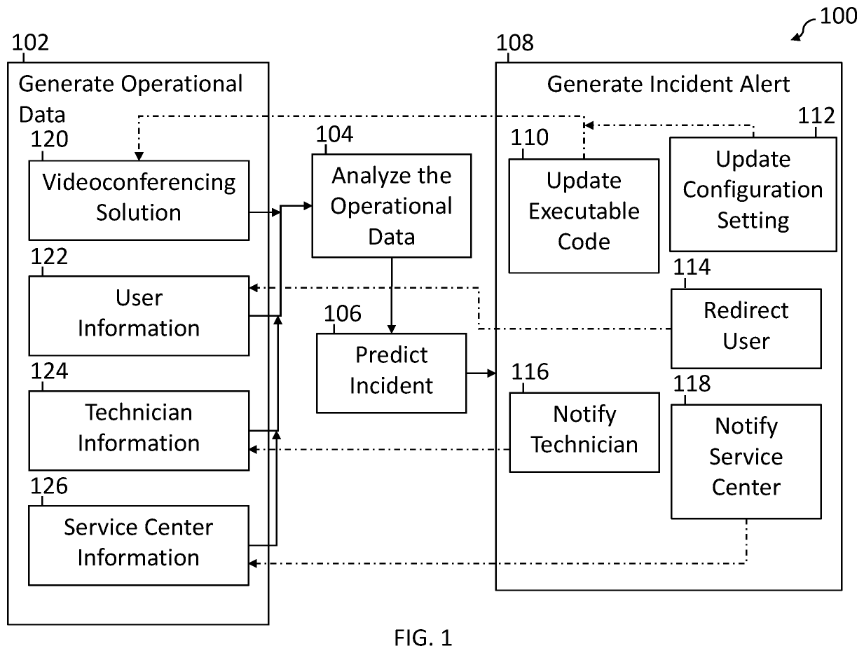

Referring now to FIG. 1, a flow diagram depicting a method 100 for a system for generating incident alerts is provided, in accordance with various examples. The method 100 includes generating operational data (102). The method 100 also includes analyzing the operational data (104). Additionally, the method 100 includes predicting an incident (106). The method 100 also includes generating an incident alert (108).

In various examples, during generation of the incident alert, the method 100 includes updating executable code (110). In some examples, during generation of the incident alert, the method 100 includes updating a configuration setting (112). In other examples, during generation of the incident alert, the method 100 includes redirecting a user (114). In various examples, during generation of the incident alert, the method 100 includes notifying a technician (116). In some examples, during generation of the incident alert, the method 100 includes notifying a service center (118).

In some examples, the operational data includes data provided by a videoconferencing solution 120, a user information 122, a technician information 124, a service center information 126, or a combination thereof. In various examples, updating the executable code updates executable code of the videoconferencing solution 120. In other examples, updating the configuration setting updates a configuration setting of the videoconferencing solution 120. In some examples, redirecting a user redirects the user that provides the user information 122. In various examples, notifying a technician notifies a technician that provides the technician information 124. In some examples, notifying a service center notifies a service center that provides the service center information 126.

As described above, a processor of the system receives the operational data. In various examples, the processor categorizes the operational data. The processor categorizes the operational data based on a class of a peripheral device, a component of the peripheral device, an executable code utilized for a videoconferencing session, a version of a videoconferencing solution utilized for the videoconferencing session, or a combination thereof, for example. In some examples, the categories are based on a type of a peripheral device. For example, the categories include audio devices, display devices, image sensors, and touchscreens. In other examples, the categories include subcategories that are based on a subclass or a model of the peripheral device. For example, the subcategories of audio devices include speakers, headsets, microphones, or a combination thereof. In another example, the subcategories of display devices include a first display device having a first model, a second display device having a second model, a third display device having a third model, or a combination thereof. In various examples, the categories are based on a component of the peripheral device. For example, the categories include batteries, storage devices, processors, executable code versions of the components, ora combination thereof.

Executable code, as used herein, includes “applications,” “software,” and “firmware.” “Applications,” “software,” and “firmware” are considered to be interchangeable in the context of the examples provided. “Firmware” is considered to be machine-readable instructions that a processor executes prior to execution of an operating system (OS), with a small portion that continues after the OS bootloader executes (e.g., a callback procedure), for example. “Applications” and “software” are considered broader terms than “firmware,” and are considered to refer to machine-readable instructions that execute after the OS bootloader starts, through OS runtime, and until the electronic device (e.g., a peripheral device) shuts down, for example.

In various examples, the electronic device comprises a Basic Input/Output System (BIOS). As used herein, a BIOS refers to hardware or hardware and machine-readable instructions to initialize, control, or operate the electronic device prior to execution of the OS of the electronic device. Machine-readable instructions included within the BIOS is software, firmware, microcode, or other programming that defines or controls functionality or operation of the BIOS. In some examples, the BIOS is implemented using machine-readable instructions, such as platform firmware of the electronic device, executable by a processor. The BIOS operates or executes prior to the execution of the OS of the electronic device. The BIOS initializes, controls, or operates components such as hardware components of the electronic device and loads or boots the OS of the electronic device.

In some examples, the BIOS provides or establishes an interface between hardware devices or platform firmware of the electronic device and the OS of the electronic device, via which the OS of the electronic device controls or operates the hardware devices or the platform firmware of the electronic device. In some examples, the BIOS implements the Unified Extensible Firmware Interface (UEFI) specification or another specification or standard for initializing, controlling, or operating an electronic device.

In various examples, the BIOS includes executable code usable to perform a power on self-test (POST), which includes hardware initialization, testing, and configuration during the boot-up process. The BIOS further includes executable code usable to launch a bootloader from a Master Boot Record (MBR), and to use the bootloader to launch the OS. After launching the OS, the BIOS is usable to provide OS runtime services (e.g., communication with peripheral devices) for the OS and applications. In other examples, UEFI BIOS is used in lieu of the BIOS. Like BIOS, UEFI BIOS includes executable code usable to perform hardware initialization, testing, and configuration during the boot-up process, to launch the OS, and to provide OS runtime services for the OS and applications. However, UEFI BIOS employs globally unique identifier (GUID) partition tables (GPTs) in lieu of MBRs. For the sake of convenience and brevity, this description uses the term BIOS generally to refer to both BIOS and UEFI BIOS. The OS comprises executable code that manages both hardware and executable code (e.g., applications) after an electronic device has booted up.

In various examples, utilizing the categories, the processor analyzes the operational data to predict an incident. In some examples, the processor utilizes a time series regression processing to analyze the categories. In various examples, the time series regression processing utilizes a moving average to analyze the categories. For example, a moving average is determined for a category. The processor determines a measurement window. The measurement window is a specified interval, in some examples. The specified interval is based on a number of measurements recorded during a time period. For example, responsive to recording a measurement every minute, the specified interval is three minutes, five minutes, ten minutes, or some other multiplier of the number of measurements. In other examples, the measurement window is a specified number of measurements. For example, the processor utilizes three measurements for the measurement window, where the three measurements are a current measurement and two measurements immediately preceding the current measurement. In another example, the processor utilizes two measurements for the measurement window, where the two measurements are a current measurement and an immediately preceding measurement to the current measurement. The processor averages operational data of the category for the measurement window. The processor then increments the measurement window by a number of measurements. For example, the processor increments the measurement window by one measurement. In a category having ten measurements, a measurement window of three measurements, and an increment of one measurement, the processor determines eight moving averages (e.g., measurements 1-3, measurements 2-4, measurements 3-5, measurements 4-6, measurements 5-7, measurements 6-8, measurements 7-9, measurements 8-10). Utilizing the moving averages, the processor predicts a future measurement of the category.

In some examples, the processor compares the future measurement of the category to a threshold value. In various examples, the threshold value is specified by a technical specification. For example, the category is for a battery and the threshold value is for a battery capacity. Utilizing the time series regression processing, the processor determines that the battery capacity for the battery is decreasing over time and will fall below the threshold value in a number of days. Responsive to the prediction of the incident, the processor generates an incident alert. For example, the processor generates an incident alert for the battery having the decreasing battery capacity. The processor generates a report that indicates a location of the battery, a videoconferencing solution including the battery, a peripheral device of the videoconferencing solution that includes the battery, a recommendation for replacing the battery within the number of days, an estimation of when the battery capacity will fall below the threshold value, or a combination thereof. In some examples, the processor determines a technician, a service center, or a combination thereof, that has a replacement battery in inventory. The processor generates an incident notification and causes the report to be transmitted to the technician, the service center, or the combination thereof. In various examples, the incident notification generates a work ticket for the incident.

By generating the incident alert and notifying the technician, the service center, or the combination thereof, the processor enables resolution of the incident prior to an actual occurrence of the incident that could interfere with a videoconferencing session. By notifying the technician, the service center, or the combination thereof, that has a replacement for the peripheral device associated with the incident, the processor reduces an amount of time to rectify the incident. In some examples, the processor aggregates incident alerts of a location having multiple videoconferencing solutions to enhance productivity of the technician who resolves the incidents.

In various examples, the technician, the service center, or the combination thereof services the incident and enters operational data regarding the service of the videoconferencing solution (e.g., technician information 124, service center information 126). Based on the operational data, the processor updates the threshold value utilized to generate the prediction of the incident, a recommendation for resolving the incident, or a combination thereof. By updating the threshold value, the processor enhances an accuracy of the prediction of an incident that is based on the threshold value. By updating the recommendation for resolving the incident, the processor enables other technicians and service centers unfamiliar with the incident to resolve future occurrences of the incident.

In some examples, the processor determines a failure rate of a peripheral device or a component of the peripheral device of a first videoconferencing solution located at a first location. In various examples, responsive to the failure rate exceeding a specified failure threshold, the processor generates an incident alert. In other examples, responsive to the failure rate exceeding the specified threshold, the processor determines the failure rate of the same peripheral device, the same component of the peripheral device, or a combination thereof, for a second videoconferencing solution located at a second location. The second location is a different room in a same building as the first location, for example. In another example, the second location is in a different building than the first location. Responsive to the failure rate exceeding the specified threshold at multiple locations, the processor generates a report that includes the peripheral device, the component of the peripheral device, the failure rate, the location of the peripheral device, a recommendation, or a combination thereof. In some examples, the processor recommends replacing the peripheral device with a different peripheral device that performs a same function as the peripheral device. The processor causes transmission of the report to a system administrator, for example. In another example, the processor causes transmission of the report to the technicians and the service centers of the videoconferencing solutions having the peripheral device or the component of the peripheral device.

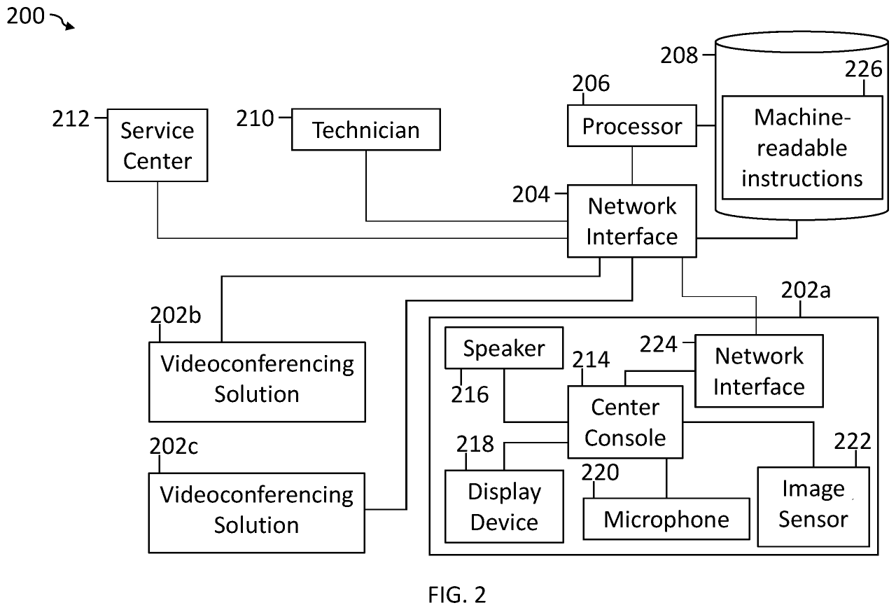

Referring now to FIG. 2, a block diagram depicting a system 200 for generating incident alerts is provided, in accordance with various examples. The system 200 includes videoconferencing solutions 202a, 202b, 202c, a network interface 204, a processor 206, a storage device 208, an electronic device of a technician 210, and an electronic device of a service center 212. The electronic device of the technician 210 and the electronic device of the service center 212 are desktops, laptops, notebooks, tablets, smartphones, or a combination thereof, for example. The videoconferencing solutions 202a, 202b, 202c are any suitable electronic device or electronic devices that includes executable code that enables videoconferencing sessions. The videoconferencing solutions 202a, 202b, 202c are desktops, laptops, notebooks, tablets, smartphones, a combination of peripheral devices, or a combination thereof, for example. The videoconferencing solutions 202a, 202b, 202c are herein collectively referred to as the videoconferencing solutions 202.

The videoconferencing solutions 202 include multiple peripheral devices. For example, the videoconferencing solution 202a includes a center console 214, a speaker 216, a display device 218, a microphone 220, an image sensor 222, and a network interface 224. While not explicitly shown, the videoconferencing solutions 202b, 202c include multiple peripheral devices such as audio devices, image sensors, touchscreens, display devices, ora combination thereof. The audio devices include microphones, headsets, speakers, or any suitable electronic device for playing or recording sound, for example. The image sensors include cameras, video recorders, or any other suitable electronic device for capturing images, for example. The touchscreens include center consoles or any other electronic device for controlling the videoconferencing solutions 202b, 202c, for example. In some examples, the videoconferencing solutions 202 include the same models of the multiple peripheral devices. In other examples, the multiple peripheral devices of the videoconferencing solution 202a differ from the multiple peripheral devices of the videoconferencing solution 202b. In some examples, the videoconferencing solutions 202 are owned by a same enterprise. In other examples, the videoconferencing solutions 202 are owned by different enterprises.

The network interface 204, 224 enables communication over a network. The network interface 204, 224 may include a wired connection, such as Ethernet or universal serial bus (USB), or a wireless connection, such as WI-FI® or BLUETOOTH®, for example. The network is a local area network (LAN), a wide area network (WAN), a virtual private network (VPN), a client/server network, an Internet (e.g., cloud), or any other suitable system for sharing processing and memory resources, for example. The processor 206 is a microprocessor, a microcomputer, a programmable integrated circuit, a programmable gate array, or other suitable device for managing operations of the system 200 or a component or multiple components of the system 200. For example, the processor 206 is a central processing unit (CPU), a graphics processing unit (GPU), or an embedded security processor (EpSC). In another example, the processor 206 is an embedded artificial intelligence (eAI) of the network interface 204. The storage device 208 is a hard drive, a solid-state drive (SSD), flash memory, random access memory (RAM), or other suitable memory for storing data or machine-readable instructions of the system 200. While the storage device 208 is shown as a separate component of the system 200, in other examples, the storage device 208 is integrated with the processor 206.

In some examples, an electronic device (not explicitly shown) includes the network interface 204, the processor 206, and the storage device 208. In other examples, a network of electronic devices includes the network interface 204, the processor 206, the storage device 208, or a combination thereof. For example, a first electronic device includes the network interface 204, a second electronic device includes the processor 206, and a third electronic device includes the storage device 208 (e.g., enterprise cloud, public cloud, data center, server, or some other suitable storage device). The multiple electronic devices couple to the network of the system 200.

In various examples, the videoconferencing solutions 202 couple to the network interface 204. The network interface 204 is coupled to the videoconferencing solutions 202, the processor 206, the storage device 208, the electronic device of the technician 210, and the electronic device of the service center 212. The processor 206 is coupled to the network interface 204 and the storage device 208. The storage device 208 is coupled to the processor 206. The electronic device of the technician 210 is coupled to the network interface 204. The electronic device of the service center 212 is coupled to the network interface 204.

In some examples of the videoconferencing solution 202a, the center console 214 is coupled to the speaker 216, the display device 218, the microphone 220, the image sensor 222, and the network interface 224. The network interface 224 is coupled to the network interface 204, for example. In various examples, a processor (not explicitly shown) of the videoconferencing solution 202a collects the operational data of the center console 214, the speaker 216, the display device 218, the microphone 220, the image sensor 222, the network interface 224, or a combination thereof. In some examples, the processor is a processor of the center console 214. In other examples, the processor is a processor of the network interface 224. The processor causes transmission of the operational data to the network interface 204 for storage on the storage device 208, for receiving by the processor 206, or a combination thereof.

In various examples, the storage device 208 stores machine-readable instructions 226, which, when executed by the processor 206, cause the processor 206 to perform some or all of the actions attributed herein to the processor 206. The machine-readable instructions 226, when executed by the processor 206, cause the processor 206 to perform some or all of the method 100, for example. As described above with respect to FIG. 1, the processor 206 collects or receives the operational data. For example, the processor 206 receives the operational data from the videoconferencing solutions 202. In some examples, the storage device 208 stores the operational data collected from the videoconferencing solutions 202. In various examples, the processor 206 receives the operational data from the storage device 208. In other examples, a second storage device (not explicitly shown) stores the operational data collected from the videoconferencing solutions 202, and the processor 206 receives the operational data from the second storage device.

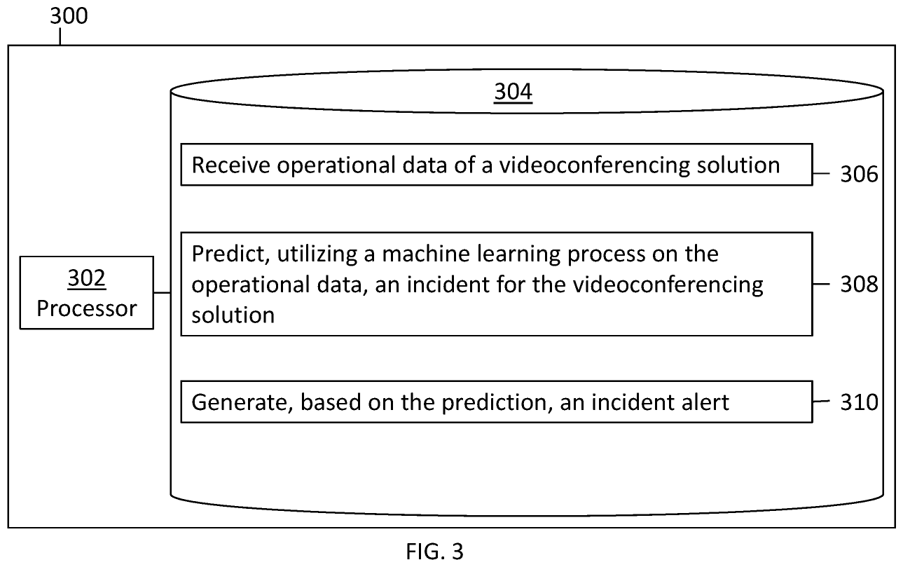

In some examples, the processor 206 categorizes the operational data, as described above with respect to FIG. 1. The processor 206 analyzes the operational data to predict an incident, as described above with respect to FIG. 1 or as described below with respect to FIG. 3. In some examples, the videoconferencing solutions 202 have the same, or some of the same, peripheral device configurations, have a same service provider that provides an executable code that enables a videoconferencing session, are owned by different enterprises, or a combination thereof. The enterprises, service providers, or a combination thereof, enable the system 200 to collect the operational data and aggregate the operational data with the operational data of other enterprises, service providers, or a combination thereof, for diagnostic purposes, for example. The processor 206 receives the operational data from the videoconferencing solutions 202 having the same, or some of the same, peripheral device configurations and aggregates the data to refine the time series regression processing, for example. In another example, the processor 206 receives the operational data from the videoconferencing solutions 202 having the same, or some of the same, peripheral device configurations and the same service provider and aggregates the data to refine the time series regression processing. The peripheral device configurations respond differently based on the executable code of the different service providers, in various examples. Responsive to the prediction of the incident, the processor 206 generates an incident alert.

By predicting incidents and generating incident alerts, the processor 206 enables correction of incidents before the user utilizes the videoconferencing solutions 202. The user experience and productivity are enhanced by ensuring the videoconferencing solutions 202 operate as intended during use. Collecting and analyzing the operational data enhances the productivity of the technician, the service center, or a combination thereof by diagnosing the incident, determining a cause of the incident, and generating a recommendation to correct the incident. Diagnosing the incident, determining the cause of the incident, generating the recommendation to correct the incident, and ensuring proper service routing for resolution of the incident enhances the productivity of the videoconferencing solutions 202 by reducing a downtime of the videoconferencing solutions 202. Aggregating data across the videoconferencing solutions 202 enhances an accuracy of predictions of the processor 206. By increasing a data pool from which the processor 206 receives the operational data, the processor 206 is able to refine its predictions, for example.

Referring now to FIG. 3, a block diagram depicting an electronic device 300 for generating incident alerts is provided, in accordance with various examples. The electronic device 300 is a desktop, a laptop, a notebook, a tablet, a smartphone, a server, a cloud computing device, or any other suitable computing device having a processor 302 able to predict incidents. The electronic device 300 includes the processor 302 and a non-transitory machine-readable medium 304. The processor 302 is the processor 206, for example. The non-transitory machine-readable medium 304 is the storage device 208, for example.

In some examples, the processor 302 is coupled to the non-transitory machine-readable medium 304. In various examples, the non-transitory machine-readable medium 304 stores machine-readable instructions, which, when executed by the processor 302, cause the processor 302 to perform some or all of the actions attributed herein to the processor 302. The machine-readable instructions are the machine-readable instructions 306, 308, 310. The machine-readable instructions 306, 308, 310 are the machine-readable instructions 226, for example.

In various examples, the machine-readable instructions 306, 308, 310, when executed by the processor 302, cause the processor 302 to generate an incident alert. The machine-readable instruction 306, when executed by the processor 302, causes the processor 302 to receive operational data of a videoconferencing solution (e.g., the videoconferencing solution 202a, 202b, 202c). As described above, the operational data of the videoconferencing solution includes data of the videoconferencing solution, a user of the videoconferencing solution, a technician of the videoconferencing solution, a service center of the videoconferencing solution, or a combination thereof. The processor 302 collects the operational data utilizing the techniques described above with respect to FIG. 2, for example. The machine-readable instruction 308, when executed by the processor 302, causes the processor 302 to predict, utilizing a machine learning process on the operational data, an incident of the videoconferencing solution. The machine-readable instruction 310, when executed by the processor 302, causes the processor 302 to generate, based on the prediction, an incident alert.

In some examples, the processor 302 utilizes an Autoregressive Integrated Moving Average (ARIMA) model for the machine learning process. The ARIMA model is trained utilizing the operational data of the videoconferencing solution. For example, the processor 302 trains the ARIMA model utilizing technical specifications of peripheral devices of the videoconferencing solution and real-time data from a videoconferencing session. The processor 302 categorizes the operational data, as described above with respect to FIG. 1, for example. The processor 302 utilizes the categories as inputs of the ARIMA model. For example, the inputs of the ARIMA model include location information, user information, information of a videoconferencing session, peripheral devices, executable code, batteries, storage devices, warranties, availability of executable updates, previous incidents, inventories, or a combination thereof. In various examples, during the training process of the ARIMA model, the processor 302 adjusts weights of the ARIMA model so that the operational data is within a specified threshold of outputs of the ARIMA model. The processor 302 utilizes back propagation to adjust the weights of the ARIMA model, for example. The processor 302 validates the ARIMA model by removing a category from the ARIMA model and testing a performance of the ARIMA model. The processor 302 validates the ARIMA model by testing the performance of the ARIMA model with a different category removed during each iteration of testing.

The ARIMA model includes an autoregressive (AR) process, an integrative (I) process, and a moving average (MA) process. In some examples, the AR process includes the processor 302 predicting a value of a time interval utilizing a value of another time interval that immediately precedes the time interval. In other examples, the AR process includes the processor 302 predicting the value of the time interval utilizing two values of other consecutive time intervals that immediately precede the time interval. In various examples, the I process includes the processor 302 determining a difference between a current value and a value immediately preceding the current value. The I process also includes the processor 302 replacing the current value with the difference. In some examples, the MA process includes the processor 302 utilizing an MA model on delayed measurements and adjusting a current value based on a dependency between the current value and an error value of the MA model.

In various examples, the processor 302 receives the operational data of the videoconferencing solution from the service provider of the executable code for enabling a videoconferencing session. The operational data includes a user identifier (e.g., user id, name) of the videoconferencing session utilizing the videoconferencing solution, a start time of the videoconferencing session, an end time of the videoconferencing session, a bitrate of an audio signal, a bitrate of a video signal, a latency of the audio signal, a latency of the video signal, a jitter of the audio signal, a jitter of the video signal, an average loss rate of the audio signal, an average loss rate of the video signal, an upper threshold loss of the audio signal, an upper threshold loss of the video signal, a resolution of the video signal, a frame rate of the video signal, a processor usage rate of the videoconferencing solution, an Internet Protocol (IP) address of the videoconferencing solution, a physical location of the videoconferencing solution, or a combination thereof. The processor 302 utilizes the ARIMA model on the operational data to predict an incident of the videoconferencing solution. For example, the ARIMA model includes a benchmark of the videoconferencing solution. The benchmark includes an identifier of the videoconferencing solution, an OS of the videoconferencing solution, a type of the videoconferencing solution (e.g., desktop, laptop, notebook, tablet), a threshold audio loss, a threshold video loss, a threshold processor usage, or a combination thereof. The processor 302 utilizes the operational data as inputs to the ARIMA model that includes the benchmark of the videoconferencing solution. The processor 302 determines that an output of the ARIMA model is a predicted failure rate of the videoconferencing solution. The processor 302 determines whether the predicted failure rate exceeds a failure rate threshold. Responsive to a determination that the predicted failure rate exceeds the failure rate threshold, the processor 302 predicts an incident and generates an incident alert.

In various examples, generating the incident alert includes the processor 302 causing transmission of an executable code update of the videoconferencing solution, causing transmission of a configuration setting update of the videoconferencing solution, redirecting a user of the videoconferencing solution, notifying a technician of the videoconferencing solution, notifying a service center of the videoconferencing solution, or a combination thereof. For example, responsive to a difference between the predicted failure rate and the failure rate threshold exceeding a first threshold, the processor 302 causes a status of a location of the videoconferencing solution to change to unavailable, generates an incident alert for a technician of the videoconferencing solution, generates a report recommending the technician prioritize the incident, or a combination thereof. In various examples, responsive to a scheduled videoconferencing session occurring at the location, the processor 302 notifies the user that a different location is available to use instead. In another example, responsive to a difference between the predicted failure rate and the failure rate threshold exceeding a second threshold, the processor 302 generates an incident alert for a technician of the videoconferencing solution, generates a report recommending the technician service the incident within a specified number of days, or a combination thereof.

Utilizing the machine learning process to predict incidents enables the processor 302 to process a larger quantity of data in a faster and more efficient manner than a technician, a service center, ora combination thereof. The machine learning process enables the processor 302 to aggregate data across multiple videoconferencing solutions and enhance an accuracy of predictions of the processor 302. The machine learning process enables the processor 302 to refine failure rate thresholds and resulting recommendations based on the failure rate thresholds, for example.

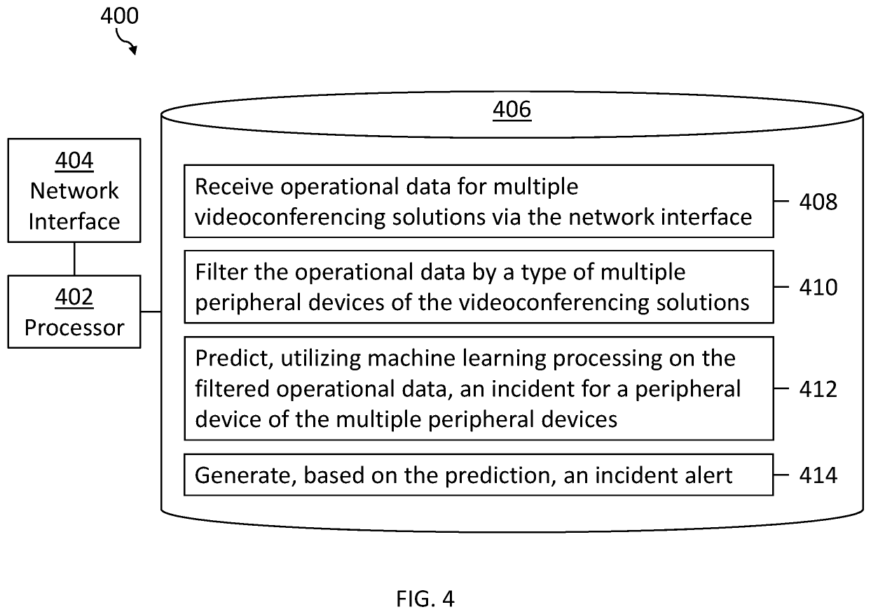

Referring now to FIG. 4, a block diagram depicting a system 400 for generating incident alerts is provided, in accordance with various examples. The system 400 is the system 200, for example. The system 400 is a server, a cloud computing device, or other suitable computing system. The system 400 includes a processor 402, a network interface 404, and a storage device 406. The processor 402 is the processor 206, 302, for example. The network interface 404 is the network interface 204, for example. The storage device 406 is the storage device 208 or the non-transitory machine-readable medium 304, for example.

In various examples, the processor 402 is coupled to the network interface 404 and the storage device 406. In some examples, the storage device 406 stores machine-readable instructions, which, when executed by the processor 402, cause the processor 402 to perform some or all of the actions attributed herein to the processor 402. The machine-readable instructions are the machine-readable instructions 408, 410, 412, 414. The machine-readable instructions 408, 410, 412, 414 when executed by the processor 402, cause the processor 402 to generate an incident alert. The machine-readable instruction 408, when executed by the processor 402, causes the processor 402 to receive operational data of multiple videoconferencing solutions via the network interface 404. The machine-readable instruction 410, when executed by the processor 402, causes the processor 402 to filter the operational data by a type of multiple peripheral devices of the videoconferencing solutions. The machine-readable instruction 412, when executed by the processor 402, causes the processor 402 to predict, utilizing machine learning processing on the filtered operational data, an incident of a peripheral device of the multiple peripheral devices. Based on the prediction, the machine-readable instruction 414, when executed by the processor 402, causes the processor 402 to generate an incident alert.

As described above with respect to FIG. 1, the processor 402 categorizes the operational data based on a class of a peripheral device. As described above with respect to FIG. 2, the multiple peripheral devices may have the same, or some of the same, peripheral device configurations. The processor 402 determines the type of the multiple peripheral devices by a class, a subclass, a model, or a combination thereof, of the multiple peripheral devices. For example, the processor 402 determines the type is audio devices. In another example, the processor 402 determines the type is microphones, a subclass of audio devices. In yet another example, the processor 402 determines the type is a particular model of a headset, a model of a subclass of headsets of the class of audio devices.

In various examples, the processor 402 utilizes the type of multiple peripheral devices to filter the operational data of the multiple videoconferencing solutions to exclude operational data unrelated to the type. For example, the processor 402 utilizes the type of multiple peripheral devices to exclude historical data, real-time data, or a combination thereof that is not the historical data, real-time data, or the combination thereof of the type. In some examples, the processor 402 determines the type of multiple peripheral devices utilized to filter the operational data based on a recall status of the type of the multiple peripheral devices, based on an availability of an executable code update of the type of the multiple peripheral devices, based on an availability of a configuration setting update of the type of the multiple peripheral devices, or a combination thereof.

In some examples, the processor 402 analyzes the filtered operational data to predict an incident of a peripheral device of the multiple peripheral devices having the type. For example, the processor 402 analyzes the filtered operational data to predict an incident of the peripheral device of the multiple peripheral devices based on a recall status of the type of the multiple peripheral devices. Based on the prediction, the processor 402 generates an incident alert. The incident alert includes an incident notification for a technician, a service center, or a combination thereof, in some examples. The incident notification includes a recommendation that the technician, the service center, or the combination thereof replaces the peripheral device with a different peripheral device that performs a same function, for example.

In another example, the processor 402 analyzes the filtered operational data to predict an incident of the peripheral device of the multiple peripheral devices based on an availability of an executable code update of the type of the multiple peripheral devices. Based on the prediction, the processor 402 generates an incident alert. In various examples, to generate the incident alert, the processor 402 causes transmission of the executable code update to the videoconferencing solutions that include the type of the multiple peripheral devices. The incident alert includes an incident notification for a technician, a service center, or a combination thereof, in some examples. The incident notification includes information that the executable code of the peripheral device is updated, for example.

In yet another example, the processor 402 analyzes the filtered operational data to predict an incident of the peripheral device of the multiple peripheral devices based on an availability of a configuration setting update of the type of the multiple peripheral devices. Based on the prediction, the processor 402 generates an incident alert. In various examples, to generate the incident alert, the processor 402 causes transmission of the configuration setting update to the videoconferencing solutions that include the type of the multiple peripheral devices. The incident alert includes an incident notification for a technician, a service center, or a combination thereof, in some examples. The incident notification includes information that the configuration setting of the peripheral device is updated, for example.

By utilizing the type of multiple peripheral devices to filter the operational data of the multiple videoconferencing solutions to exclude operational data unrelated to the type, the processor 402 more efficiently processes the operational data. For example, by determining the type of multiple peripheral devices utilized to filter the operational data based on a recall status of the type of the multiple peripheral devices, based on an availability of an executable code update of the type of the multiple peripheral devices, based on an availability of a configuration setting update of the type of the multiple peripheral devices, or a combination thereof, the processor 402 automatically resolves incidents without utilizing additional resources such as a technician, a service center, or a combination thereof.

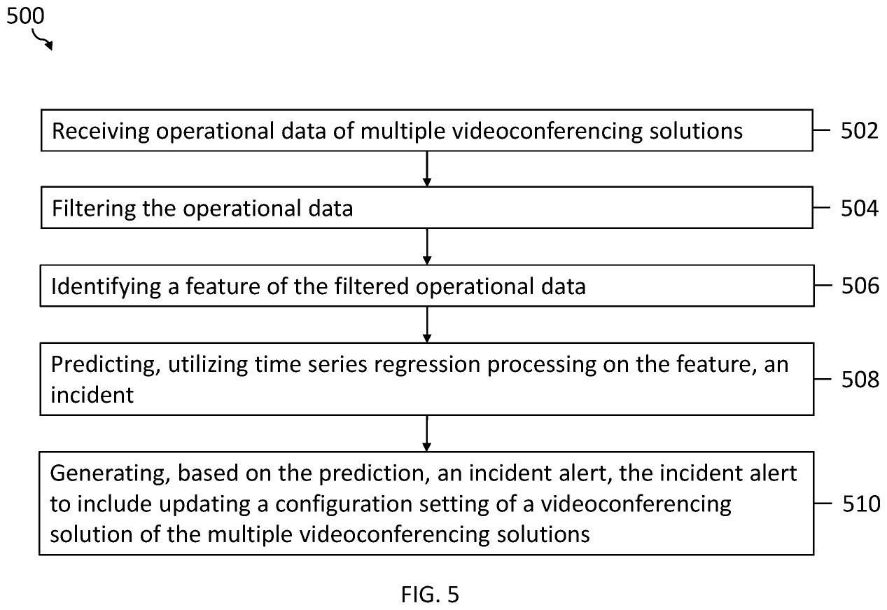

Referring now to FIG. 5, a flow diagram depicting a method 500 for a system (e.g., the system 200, 400) for generating incident alerts is provided, in accordance with various examples. The method 500 includes receiving operational data of multiple videoconferencing solutions (502). The method 500 also includes filtering the operational data (504). Additionally, the method 500 includes identifying a feature of the filtered operational data (506). The method 500 also includes predicting, utilizing time series regression processing on the feature, an incident (508). Additionally, the method 500 includes generating, based on the prediction, an incident alert, the incident alert to include updating a configuration setting of a videoconferencing solution of the multiple videoconferencing solutions (510).

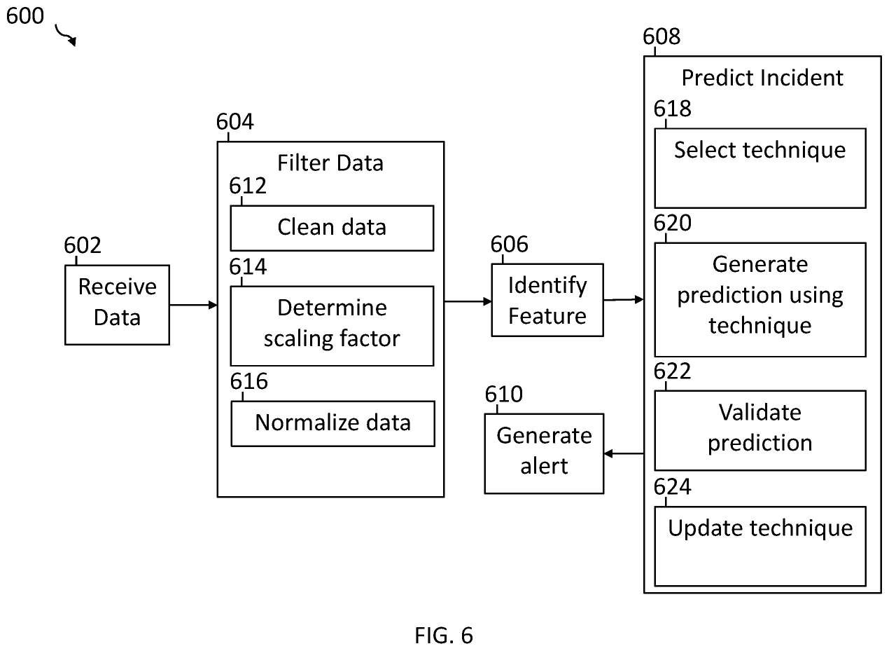

A processor (e.g., the processor 206, 302, 402) receives the operational data of multiple videoconferencing solutions, as described above with respect to FIG. 2, for example. The processor filters the operational data, as described above with respect to FIG. 4 or as described below with respect to FIG. 6, for example. In various examples, the processor identifies the feature of the filtered operational data based on a quality of an audio signal, a video signal, or a combination thereof. The service provider of the executable code that enables a videoconference solution provides the quality of the audio signal, the video signal, or the combination thereof. The processor identifies a type of a peripheral device that affects the quality of the audio signal, the video signal, or the combination thereof. The processor identifies the type of the peripheral device utilizing the techniques described above with respect to FIG. 1 or 4, for example. In various examples, the processor utilizes time series regression processing on the operational data associated with the feature, the type of the peripheral device that affects the feature, or a combination thereof.

Referring now to FIG. 6, a flow diagram depicting a method 600 for a system (e.g., the system 200, 400) for generating incident alerts is provided, in accordance with various examples. The method 600 includes receiving data (602). The method 600 also includes filtering the data (604). Additionally, the method 600 includes identifying a feature of the data (606). The method 600 includes predicting an incident (608). The method 600 also includes generating an alert (610).

In various examples, during filtering the data, the method 600 includes cleaning the data (612). Cleaning the data includes removing duplicate values, replacing null values with previous values, or a combination thereof. The method 600 also includes determining a scaling factor (614). The scaling factor is utilized to update an allocation of processing capacity, storage device capacity, or a combination thereof, of the system. The scaling factor enables the system to increase a processing capacity, a storage device capacity, or a combination thereof, to accommodate for an increase in data received by the system, for example. Additionally, the method 600 includes normalizing the data (616). Utilizing feed-forward or feed-backward techniques, the data is normalized based on threshold values, for example.

In some examples, during prediction of the incident, the method 600 includes selecting a technique (618). The technique is a time series regression process, a machine learning process, or a combination thereof, for example. The time series regression process is the time series regression process described above with respect to FIG. 1 or 2, for example. In another example, the machine learning process is the machine learning process described above with respect to FIG. 3 or 4. The method 600 also includes generating a prediction utilizing the technique (620). Additionally, the method 600 includes validating the prediction (622). The prediction is validated utilizing the techniques described above with respect to FIG. 3, for example. Responsive to the validation, the method 600 includes updating the technique utilizing the prediction (624). The technique is updated utilizing the techniques as described above with respect to FIG. 1, for example.

Utilizing the method 500, 600, the system corrects incidents before the incidents impact an audio quality, a video quality, or a combination thereof, of the videoconferencing solution. The user experience and productivity are enhanced by ensuring the videoconferencing solution operates as intended during use.

Unless infeasible, some or all of the method 100, 500, 600 may be performed by a processor (e.g., the processor 206, 302, 402) concurrently or in different sequences and by circuitry of a system (e.g., the system 200, 400, the electronic device 300), execution of machine-readable instructions of the system (e.g., the machine-readable instructions 226), or a combination thereof. For example, the method 100, 500, 600 is implemented by machine-readable instructions stored to a storage device (e.g., the storage device 208, 406, the non-transitory machine-readable medium 304, or another storage device not explicitly shown of the system, circuitry (some of which is not explicitly shown) of the system, or a combination thereof. The processor executes the machine-readable instructions to perform some or all of the method 100, 500, 600, for example.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component are omitted.

In the above description and in the claims, the term “comprising” is used in an open-ended fashion, and thus should be interpreted to mean “including, but not limited to . . . .” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. A non-transitory machine-readable medium storing machine-readable instructions, which, when executed by a processor, cause the processor to:
receive operational data of a videoconferencing solution;
predict, utilizing a machine learning process on the operational data, an incident of the videoconferencing solution; and
generate, based on the prediction, an incident alert.

2. The non-transitory machine-readable medium of claim 1, wherein, the operational data of the videoconferencing solution includes data of the videoconferencing solution, a user of the videoconferencing solution, a technician of the videoconferencing solution, a service center of the videoconferencing solution, or a combination thereof.

3. The non-transitory machine-readable medium of claim 1, wherein the machine learning process utilizes an Autoregressive Integrated Moving Average (ARIMA) model.

4. The non-transitory machine-readable medium of claim 3, wherein, to predict the incident of the videoconferencing solution, the processor is to:
determine an output of the ARIMA model is a predicted failure rate of the videoconferencing solution; and
determine that the predicted failure rate exceeds a failure rate threshold.

5. The non-transitory machine-readable medium of claim 1, wherein generating the incident alert includes updating an executable code of the videoconferencing solution, updating a configuration setting of the videoconferencing solution, redirecting a user of the videoconferencing solution, notifying a technician of the videoconferencing solution, notifying a service center of the videoconferencing solution, or a combination thereof.

6. A system, comprising:
a network interface; and
a processor to:
receive operational data of multiple videoconferencing solutions via the network interface;
filter the operational data by a type of multiple peripheral devices of the videoconferencing solutions;
predict, utilizing machine learning processing on the filtered operational data, an incident of a peripheral device of the multiple peripheral devices; and
generate, based on the prediction, generate an incident alert.

7. The system of claim 6, wherein a videoconferencing solution of the multiple videoconferencing solutions includes an audio device, an image sensor, a touchscreen, a display device, a second network interface, or a combination thereof.

8. The system of claim 6, wherein the processor is to determine the type of the multiple peripheral devices by a class, a subclass, a model, or a combination thereof, of the multiple peripheral devices.

9. The system of claim 6, wherein the processor is to determine the type of multiple peripheral devices utilized to filter the operational data based on a recall status of the type of the multiple peripheral devices, based on an availability of an executable code update of the type of the multiple peripheral devices, based on an availability of a configuration setting update of the type of the multiple peripheral devices, or a combination thereof.

10. The system of claim 6, wherein to generate the incident alert, the processor is to cause transmission of an executable code update to the multiple videoconferencing solutions having the type of the multiple peripheral devices.

11. The system of claim 6, wherein to generate the incident alert, the processor is to cause transmission of a configuration setting update to the multiple videoconferencing solutions having the type of the multiple peripheral devices.

12. A method, comprising:
receiving operational data of multiple videoconferencing solutions;
filtering the operational data;
identifying a feature of the filtered operational data;
predicting, utilizing a time series regression processing on the feature, an incident; and
generating, based on the prediction, an incident alert, the incident alert to include updating a configuration setting of a videoconferencing solution of the multiple videoconferencing solutions.

13. The method of claim 12, wherein filtering the operational data includes cleaning the operational data, determining a scaling factor for the operational data, normalizing the operational data, or a combination thereof.

14. The method of claim 13, wherein to clean the operational data includes removing duplicate values, replacing null values with previous values, or a combination thereof.

15. The method of claim 13, wherein the scaling factor is utilized to update an allocation of processing capacity, storage device capacity, or a combination thereof, of a system.
